(19) United States
(12) Patent Application Publication
(10) Pub. No.: US 2012/0086732 A1
(43) Pub. Date: Apr. 12, 2012

(54) DRIVING DEVICE FOR BISTABLE ELECTRO-OPTIC DISPLAY AND DRIVING METHOD THEREFOR

(75) Inventor: Jun-Hong Hsu, Tainan County (TW)

(73) Assignee: ITE TECH. INC., Hsinchu (TW)

(21) Appl. No.: 13/099,371

(22) Filed: May 3, 2011

(30) Foreign Application Priority Data
Oct. 12, 2010 (TW) 99134798

(51) Int. Cl. G09G 5/10; G09G 3/34; G06F 3/038

(52) U.S. Cl. 345/690; 345/211; 345/84

(57) ABSTRACT

A driving device and a driving method for a bistable electro-optic display are provided. The driving device includes an image processing unit, a display process module, and a scheduling module. The image processing unit receives a first update region of a display area to produce a first region update data. The display process module updates the display area according to the first region update data. During an update period for the first update region, the image processing unit can continue to receive at least one second update region, so as to produce a plurality of second region update data. After the first region is completely updated, the scheduling module controls the display process module to update the display area according to the second region update data, so as to shorten the time for updating the display area.

### CROSS-REFERENCE TO RELATED APPLICATION

This application claims the priority benefit of Taiwan application serial no. 99134798, filed Oct. 12, 2010. The entirety of the above-mentioned patent application is hereby incorporated by reference herein and made a part of this specification.

### BACKGROUND OF THE INVENTION

1. Field of the Invention

The invention generally relates to a driving method for an electro-optic display. More particularly, the invention relates to a driving method for a bistable electro-optic display which schedules the processing of update regions, so as to shorten the time for updating the display area.

2. Description of Related Art

Due to its features of being light-weight and compact, the liquid crystal display (LCD) has gradually become the display medium of the portable terminal systems (e.g., smartphones and notebook computers) in the recent years, as well as an indispensable part of daily items people use. However, due to portable terminal systems having a limited power supply, the power saving aspect of the LCD can still be improved.

The bistable electro-optic display technique has one of the most preferred power saving effects among the display technologies. In this technique, the bistable display unit (e.g. pixel) can maintain a bright or a dark state without any voltage application. The technique earns its bistable name because electricity is required only when the display frame is updated. Moreover, display technologies referred to as multi-stable display techniques can maintain the display unit (or pixel) not only in the bright or dark state, but in a plurality of gray level states while not consuming power. Furthermore, these multi-stable display techniques are a type of bistable display technique. In addition, the bistable electro-optic display technique does not utilize a backlight source to conserve electricity. In other words, a user reads on the display using light reflected thereon, and thus the user is not likely to experience eye fatigue.

Currently, a plurality of display techniques can achieve the bistable effect, for instance the electronic ink (E-ink) display technique, the cholesteric liquid crystal display (ChLED) technique, the electro-phoretic display (EPD) technique, the electrowetting display (EWD) technique, or the quick response-liquid powder display (QR-LPD) technique. Ideally, the bistable display technique can save power consumption by up to several hundred times when compared to traditional liquid crystal display techniques.

Generally speaking, however, the bistable electro-optic display medium has a slow response speed, thus lengthening the response time for updating the entire frame and restricting the application range of this type of display. Accordingly, the current bistable electro-optic technique seeks to reduce the response time for the frame update, so as to replace the LCD in the portable terminal systems.

### SUMMARY OF THE INVENTION

The invention is directed to a driving device for a bistable electro-optic display. When the driving device is updating the display area, the image processing unit continues to process other regions to be updated, so these update regions can be concurrently updated on the display area, thereby reducing the time to update the display image.

From another perspective, the invention is directed to a driving method for a bistable electro-optic display which can schedule a plurality of regions of the display area. When updating the display area, the image processing unit continues to process other regions to be updated, so these update regions can be concurrently updated on the display area, thereby reducing the time to update the display image.

The invention provides a driving device for a bistable electro-optic display, the driving device including an image processing unit, a display process module, and a scheduling module. The image processing unit receives a first update region of a display area to produce a first region update data. The display process module updates the display area according to the first region update data. The scheduling module is coupled to the image processing unit and the display process module. During an update period for the display area, the image processing unit sequentially receives a plurality of second update regions to produce a plurality of second region update data. Moreover, after the update period, the scheduling module notifies the image processing unit to transmit the second region update data to the display process module, and the display process module updates the display area according to the second region update data.

According to an embodiment of the invention, the image processing unit producing a plurality of gray level conversion data according to the pixel gray level values at a plurality of locations in the first update region and the original pixel gray level values at the same corresponding locations of the display area, in which the gray level conversion data form the first region update data.

According to an embodiment of the invention, the display process module includes an update operation unit and a timing generation unit. The update operation unit searches a gray level lookup table according to the first region update data, so as to obtain a plurality of voltage waveform schemes corresponding to each of the pixels in the first update region. The timing generation unit is coupled to the update operation unit for updating the first update region of the display area according to the voltage waveform schemes.

According to an embodiment of the invention, the display process module may produce an update signal, and when the display process module is in the update period for updating the display area, the update signal is at an update level, otherwise the update signal is at a terminate level. Accordingly, when the update signal is at the update level, the image processing unit continues to receive the second update regions to produce the second region update data. When the update signal is at the terminate level, the scheduling module notifies the image processing unit to transmit the second region update data to the display process module, and the display process module updates the display area according to the second region update data. From another perspective, the invention provides a driving method for a bistable electro-optic display, the driving method including the following steps. An image processing unit is obtained for receiving a pixel gray level difference value of a first update region of a display area to produce a first region update data. Moreover, a display process module is obtained for updating the display area according to the first region update data. Furthermore, during an update period for the display area, the image processing unit continues to receive pixel gray level difference value of at least one second update region to produce a plurality of second region update data. After the update period, notifying the image processing unit to transmit the second region update data to the display process module, and the display process module updates the display area according to the second region update data.

In summary, since the response time required by each of the display medium in the display screen is comparatively long, the update period for the display area is long. During the update period, the image processing unit according to an embodiment of the invention continues to receive other regions for processing which do not overlap with previously updated regions. Moreover, when the display area is updated next time, the display process module is used to concurrently update the update regions.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a display system.

FIG. 2 is a block diagram of a driving device for a bistable electro-optic display.

FIG. 3 is a block diagram of a driving device for a bistable electro-optic display according to a first embodiment of the invention.

FIG. 4 is a flow chart of a driving method for a bistable electro-optic display according to the first embodiment of the invention.

FIG. 5 is a schematic view of the display area and the update regions according to the first embodiment of the invention.

FIG. 6 is a schematic comparison view comparing the driving method of FIG. 2 with the driving method of FIG. 3.

### DESCRIPTION OF EMBODIMENTS

Descriptions of the invention are given with reference to the exemplary embodiments illustrated with accompanied drawings, wherein same or similar parts are denoted with same reference numerals. Moreover, elements/components/notations with same reference numerals represent same or similar parts in the drawings and embodiments.

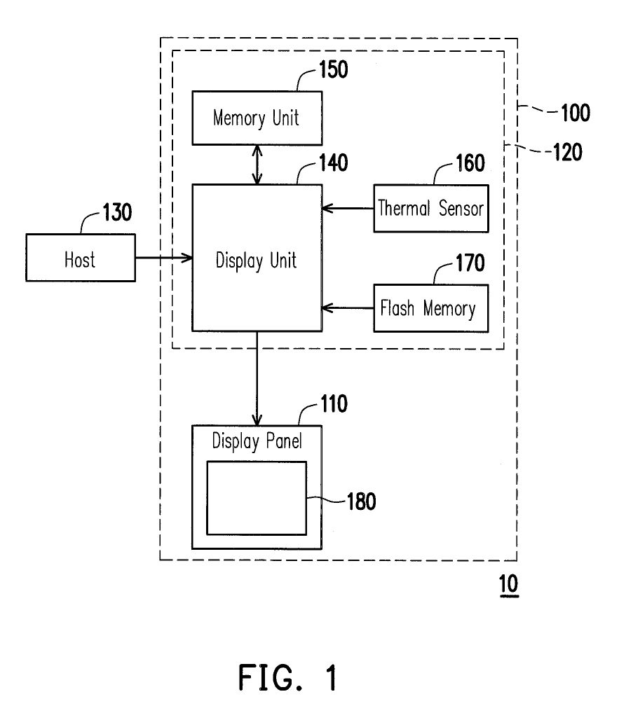

Please refer to FIG. 1, which is a block diagram of a display system 10. As shown in FIG. 1, the display system 10 includes a host 130 and a bistable electro-optic display 100. The bistable electro-optic display 100 includes a display panel 110 and a driving device 120. The host 130 may send frames or regions to be updated to the bistable electro-optic display 100. In the present embodiment, the host 130 may be a central processing unit (CPU), a digital signal processor (DSP), or other suitable devices which can be connected with the driving device 120. The driving device 120 includes a display unit 140, a memory unit 150, a thermal sensor 160, and a waveform memory 170. Moreover, the display panel 110 includes a display area 180.

In the present embodiment, the memory unit 150 is a volatile memory that can temporarily store a frame update data required by the driving device 120. The waveform memory 170 is a nonvolatile memory (e.g. a flash memory 170) storing a lookup table. The display unit 140 searches the lookup table using the update data of the pixel to be updated, so as to find the waveform required to drive the display medium of the pixel unit. The pixel unit in the present embodiment may have 16 pixel gray levels, for example from the pixel gray level value “0” of the dark state to the pixel gray level value of “15” of the bright state, although the invention does not limit the type and quantity of the pixel gray level value, or the brightness representation method. The waveform referred to herein represents the corresponding curve of the operating voltage and time for the variation of the pixel electrode, when each of the pixel units in an update region is transformed from a specific pixel gray level value (e.g. “0”) to another pixel gray level value (e.g. “5”). Typically, these waveforms include a plurality of voltage varying elements. These elements essentially fix a constant voltage for a time period. The voltage varying elements are referred to as pulses or driving pulses, and the driving scheme refers to the waveforms corresponding to all the possible pixel gray level value conversions in the bistable electro-optic display 100. Since the bistable electro-optic display 100 causes variations in the waveform of the driving pixel medium under different environmental temperatures, therefore, the thermal sensor 160 may measure the environmental temperature, and the display unit 140 may search the lookup table for the waveform required for the gray level value conversion of each pixel according to the environmental temperature and the pixel update data of the pixel unit.

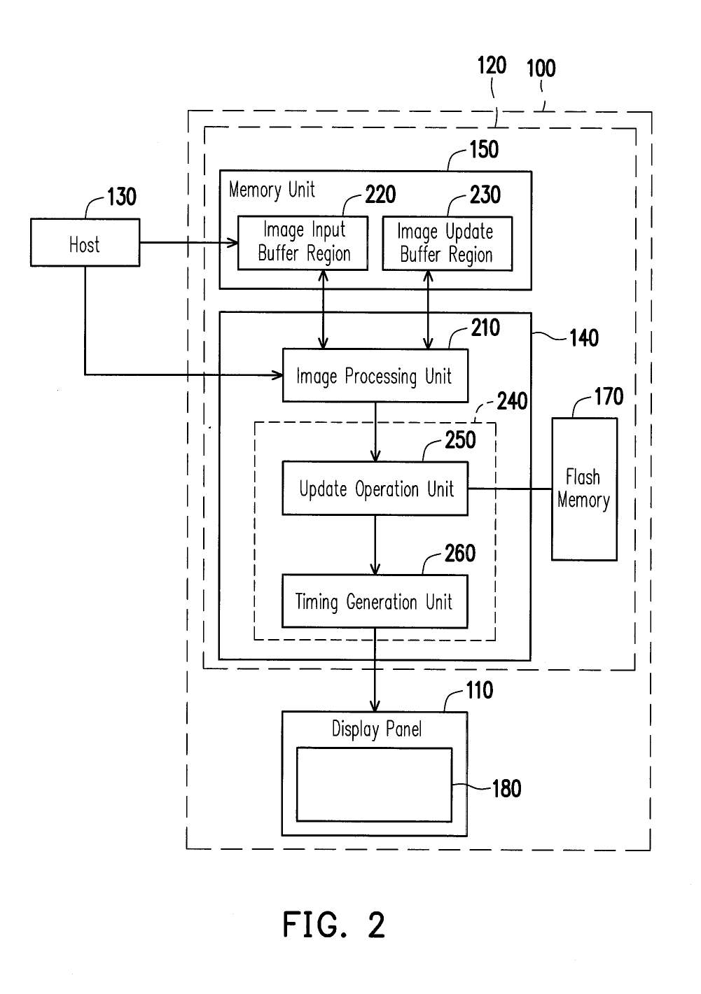

Please refer to FIG. 2, which is a block diagram of the driving device 120 of the bistable electro-optic display 100. As shown in FIG. 2, the driving device 120 includes the memory unit 150 and the display unit 140. The display unit 140 includes an image processing unit 210 and a display process module 240. Moreover, the display process module 240 includes an update operation unit 250 and a timing generation unit 260. The memory unit 150 includes an image input buffer region 220 and an image update buffer region 230. The host 130 first transmits an update region of the display area 180, and stores the update region beforehand into the image input buffer region 220. Thereafter, the image processing unit 210 receives the update region of the display area 180. Next, the image processing unit 210 integrates the pixel gray level value of each pixel in the update region, and the pixel data of the display area stored in the image update buffer region 230 (e.g. the pixel gray level value already displayed on the display area 180), so as to generate a region update data of the update region, and to store the region update data in the image update buffer region 230 of the memory unit 150.

After the update data is generated, the image processing unit 210 directly transmits the region update data of the update region to the display process module 240, and the display process module 240 updates the display area 180 according to the region update data of the update region. More specifically, the update operation unit 250 reads the region update data through the image process unit 210, and the region update data is used to search the lookup table in the flash memory 170, so as to obtain a plurality of voltage waveform schemes corresponding to each of the pixels. Moreover, the timing generation unit 260 sequentially transmits the voltage waveform schemes to the display panel 110 so as to update the display area 180.

As illustrated in the present embodiment, after receiving the update region transmitted by the host 130, the driving device 120 generates the update data, searches the lookup table, and updates the display area 180. Since the pixel medium of the bistable electro-optic display 100 has a slow response speed, an update period for the update operation unit 250 to use the timing generation unit 260 to update the display area 180 after searching the lookup table is long, therefore the image processing unit 210 maintains in a waiting state at this time. Accordingly, when the display process module 240 is in the update period, the image processing unit 210 of the present embodiment can continue to receive and process the subsequent regions to be updated. After the display process module 240 completes updating the previous region, the new regions are concurrently updated on the display area 180.

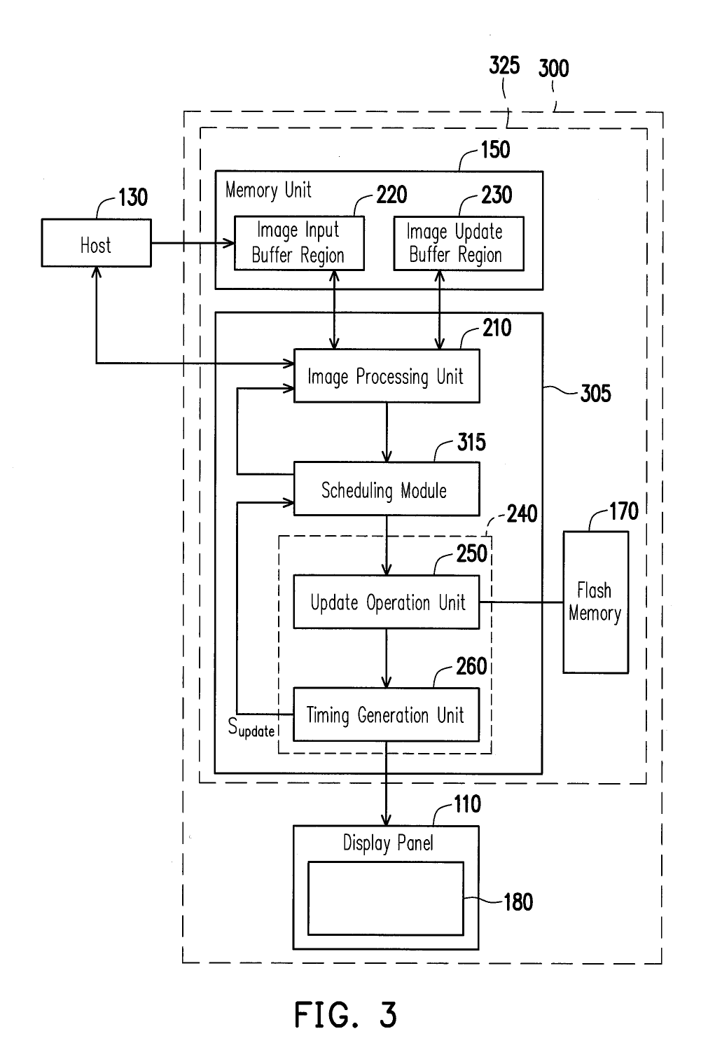

Please refer to FIG. 3, which is a block diagram of a driving device 325 of a bistable electro-optic display 300 according to a first embodiment of the invention. As shown in FIG. 3, the present embodiment is similar to the aforementioned embodiment, therefore a description of the identical portions is not repeated. A difference therebetween is in that a display unit 305 of a driving device 325 includes a scheduling module 315. During the update period for the display area 180, the image processing unit 210 notices that the display area 180 has not been fully updated through the scheduling module 315, so that the image processing unit 210 can continue to receive the regions to be updated from the host 130. Moreover, these regions to be updated and the image data of the display area 180 in the image update buffer region 230 are used to generate the update data of the regions to be updated. In addition, the regions to be updated transmitted by the host 130 do not overlap the previous update region. Moreover, in the present embodiment the scheduling module 315 blocks the image processing unit 210 so the update data of the regions to be updated cannot be transmitted to the display process module 240. Only after the previous region completes updating, the scheduling module notifies the image processing unit 210 to concurrently transfer the update data of the regions to be updated to the display process module 240, so as to update the display area 180 according to the processed update data of the regions to be updated.

Continuing reference to FIG. 3, in the present embodiment, the timing generation unit 260 of the display process module 240 may generate an update signal S_{update}, so as to notify the scheduling module 315 whether the bistable electro-optic display is in the update period. In other words, when the display process module 240 is in the update period of the update display region, the update signal S_{update} is at an update level (e.g. high level), or the update signal S_{update} is at a terminate level (e.g. low level).

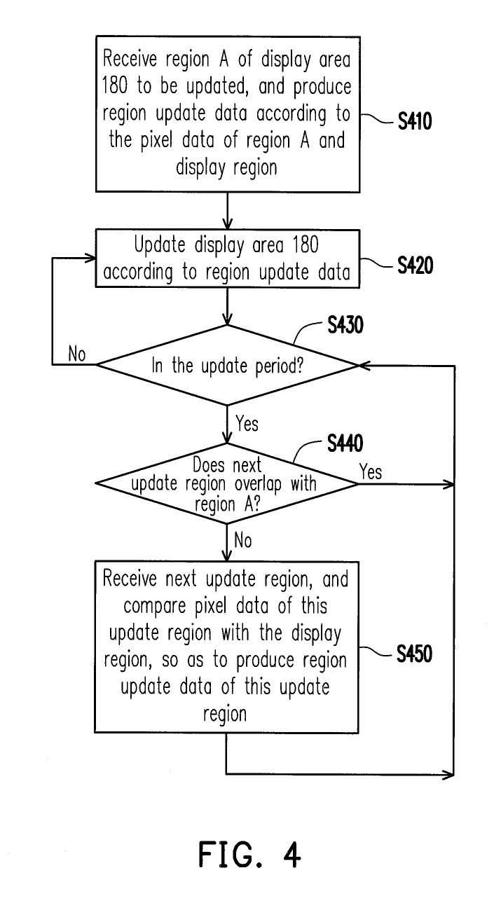

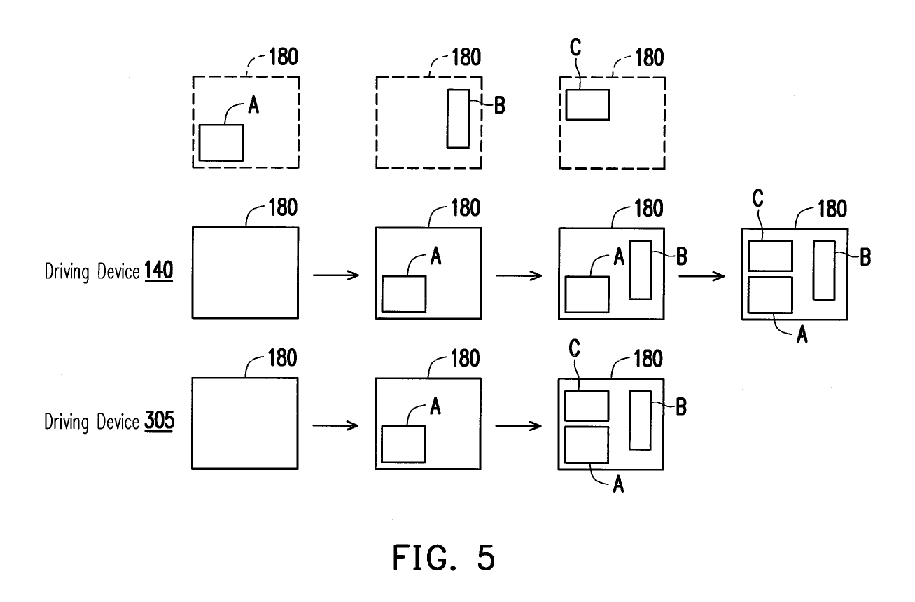

In order for people having ordinary skill in the art to better understand the invention, a driving method for the bistable electro-optic display 300 according to the embodiment of FIG. 3 is further illustrated in the following. Please refer to FIGS. 4 and 5, in which FIG. 4 is a flow chart of a driving method for the bistable electro-optic display 300 according to the first embodiment of the invention, and FIG. 5 is a schematic view of the display area 180 and the update region according to the first embodiment of the invention. Assume, for instance, that a transmission sequence of the host 130 for sending the regions to be updated is a region A, a region B, and a region C. Moreover, regions A, B, and C do not overlap each other.

In the driving device 120 of the bistable electro-optic display 100, the image processing unit 210 processes the region A to produce the region update data of the region A (assuming a time to produce the update data of the region A is T_{PA}), and the display process module 240 is used to update the display area 180 (assuming a time to update the display area 180 is T_{UA}). Thereafter, the image processing unit 210 processes the region B to produce the region update data of region B (T_{PB}), the display process module 240 uses the region update data of the region B to update the display area 180 (T_{UB}), and so forth. Accordingly, the driving device 120 of the bistable electro-optic display 100 spends a time T_{PA}+T_{UA}+T_{PB}+T_{UB}+T_{PC}+T_{UC} to update the regions A, B, and C on the display area 180.

According to an embodiment of the invention, a driving method for the bistable electro-optic display 300 first enters a Step 410, in which the image processing unit 210 receives the region A of the display area 180 to be updated, and the image processing unit 210 uses each of the pixel gray level values in the region A and the original pixel gray level value at the same corresponding locations of the display area 180 stored in the image update buffer region 230, so as to produce a plurality of gray level conversion data. The gray level conversion data may be form the region update data SA of the region A (i.e. the time spent is T_{PA}). Next, in a Step S420, the display process module 240 updates the display area 180 according to the region update data SA of the region A (i.e. the time spent is T_{UA}), so as to enter the update period.

Continuing reference to FIG. 4, in a Step S430, the scheduling module 315 determines whether the bistable electro-optic display 300 is in the update period according to the update signal S_{update} of the timing generation unit 260. When the image processing unit 210 is notified from the scheduling module 315 that the display process module 240 has not completely updated the display area 180 (i.e. during the update period and the update signal is S_{update} at the high level), the host 130 continues to transmit a next update region B. When the region A and the subsequently transmitted region B do not overlap (Step S440), the process enters a Step S450. In Step S450, the region B is processed so as to obtain the region update data SB of the region B, and the region update data SB is stored in the image update buffer region 230. At this time, the scheduling module 315 of the present embodiment blocks the image processing unit 210, so the region update data of the region B cannot be transmitted by the image processing unit 210 to the display process module 240.

When the image processing unit 210 has finished processing the region update data SB of the region B, then the process enters the Step S430 from the Step S450. When the display process module 240 has not completely updated the display area 180 (i.e. still in the update period), then the host 130 continues to transmit a next update region C. Moreover, when the region C to be updated next does not overlap with the regions A and B, then the process enters the Step S450 from the Step S430 and the Step S440, so the image processing unit 210 processes the region C, and accordingly obtains and stores a region update data SC of the region C.

It should be noted that, the image processing unit 210 according to another embodiment of the invention may simultaneously process a plurality of update regions to produce the update data by using a plurality of hardware frameworks. For example, the image processing unit 210 may simultaneously process update regions B and C to obtain the corresponding region update data SB and SC, and thereby enhance the process efficiency of the image processing unit 210. Moreover, in other embodiments of the invention, when the regions D, E, F . . . (not drawn) to be updated and sequentially transmitted by the host 130 do not overlap with the previous regions A, B, and C, and the bistable electro-optic display 300 is still in the update period, the Step S450 is continually executed so the image processing unit 210 sequentially processes regions D, E, F . . . so as to obtain the region update data SD, SE, SF . . . of the regions D, E, F . . . . Moreover, the region update data SD, SE, SF . . . are stored in the image update buffer region 230 to await a simultaneous update. In the Step S440, when the next update region D is determined to overlap the processed update regions B and C or the region A being updated, then the process waits for the update of the display area 180 to be completed (i.e. the region A is updated on the display area 180) before updating the region update data SB and SC of the processed update regions B and C. When the update regions B and C have all been updated, then the overlapping update region D is processed. However, the processing method of the overlapping region D is not limited to the description elaborated above.

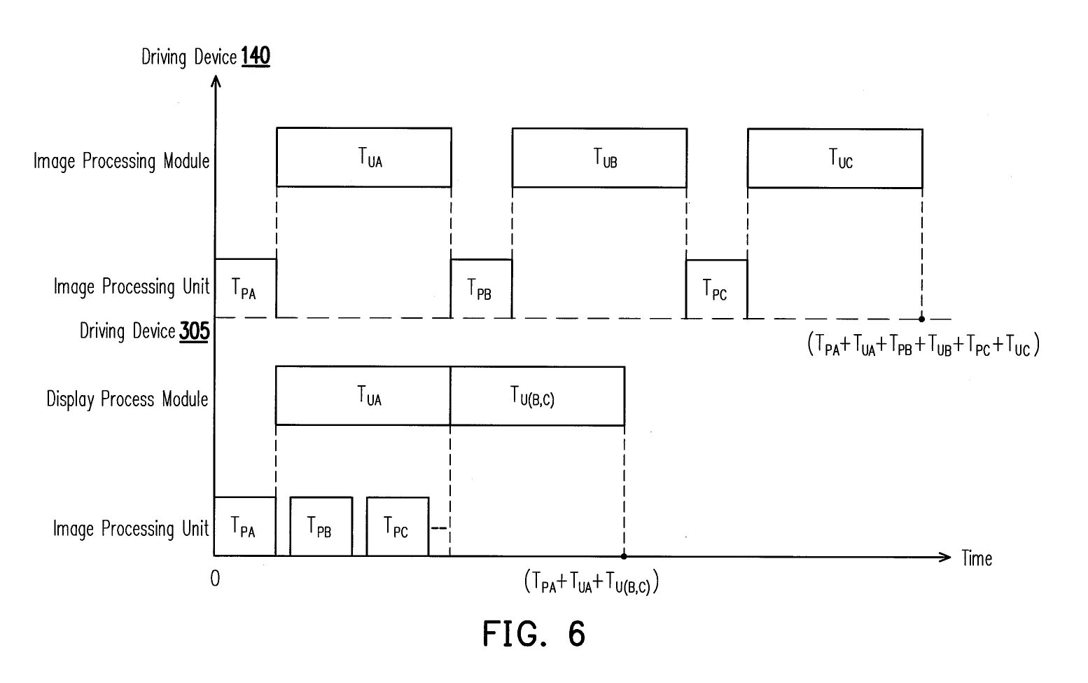

In the Step S430, when the scheduling module 315 determines the bistable electro-optic display 300 is not in the update period (i.e. the display process module 240 has already updated the region A on the display area 180), the process returns to the Step S420. Accordingly, the display process module 240 updates the display area 180 in accordance with the region update data SB and SC in the image update buffer region 230 (i.e. the time spent is T_{U(B′C)}). Please refer to FIG. 6, which is a schematic comparison view comparing the driving method of FIG. 2 with the driving method of FIG. 3. As shown in FIG. 6, the time spent by the driving device 325 of the bistable electro-optic display 300 to update the regions A, B, and C on the display area 180 is T_{PA}+T_{UA}+T_{U(B′C)}, assuming for FIG. 6 the time spent to update the display area 180 each time is approximately the same (i.e. T_{UA}≈T_{UB}≈T_{UC}≈T_{U(B′C)}). In comparison, the time spent by the driving device 120 of the bistable electro-optic display 100 to update the regions A, B, and C on the display area 180 is T_{PA}+T_{UA}+T_{PB}+T_{UB}+T_{PC}+T_{UC}. Therefore, since the driving device 325 controls the image processing unit 210 to process regions B and C to produce the update data while updating the display area 180, the times T_{PB}, T_{PC} and T_{UB} are saved. Thus, the driving device 325 of the bistable electro-optic display 300 can further reduce its update time in comparison with the driving device 120 of the bistable electro-optic display 100 depicted in FIG. 2.

In view of the foregoing, since the response time required by each of the display mediums in the display screen is comparatively long, the update period to for the display area is long. During the update period, the image processing unit according to an embodiment of the invention continues to receive other update regions to be processed, and when the display area is updated next time, the display process module is used to update the update regions concurrently.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A driving device for a bistable electro-optic display, comprising:
an image processing unit for receiving a first update region of a display area to produce a first region update data;
a display process module for updating the display area according to the first region update data; and
a scheduling module coupled to the image processing unit and the display process module, wherein, during an update period for the display area, the image processing unit sequentially receives at least one second update region, so as to produce at least one second region update data, and after the update period, the scheduling module notifies the image processing unit to transmit the second region update data to the display process module, and the display process module updates the display area according to the second region update data.

2. The driving device for the bistable electro-optic display as claimed in claim 1, wherein the image processing unit produces a plurality of gray level conversion data according to the pixel gray level values at a plurality of locations in the first update region and the original pixel gray level values at the corresponding locations of the display area, wherein the gray level conversion data form the first region update data.

3. The driving device for the bistable electro-optic display as claimed in claim 1, wherein the display process module comprises:
an update operation unit for searching a gray level lookup table according to the first region update data, so as to obtain a plurality of voltage waveform schemes corresponding to each of the pixels in the first update region; and
a timing generation unit coupled to the update operation unit for updating the first update region of the display area according to the voltage waveform schemes.

4. The driving device for the bistable electro-optic display as claimed in claim 1, wherein at least one display process module produces an update signal, and when the display process module is in the update period for updating the display area, the update signal is at an update level, otherwise the update signal is at a terminate level, and
when the update signal is at the update level, the image processing unit continues to receive the second update regions to produce the second region update data, and when the update signal is at the terminate level, the scheduling module notifies the image processing unit to transmit the second region update data to the display process module, and the display process module updates the display area according to the second region update data.

5. A driving method for a bistable electro-optic display, comprising:
obtaining an image processing unit for receiving a pixel gray level difference value of a first update region of a display area to produce a first region update data;
obtaining a display process module for updating the display area according to the first region update data;
during an update period for the display area, the image processing unit sequentially receiving pixel gray level difference value of at least one second update region to produce at least one second region update data; and
after the update period of the first region, notifying the image processing unit to transmit the second region update data to the display process module, and the display process module updating the display area according to the second region update data.

6. The driving method as claimed in claim 5, wherein the step of producing the first region update data according to the first update region comprises:
comparing the gray level values of a plurality of pixel locations in the first update region with the original pixel gray level values at the corresponding locations of the display area, so as to produce a plurality of gray level conversion data, wherein the gray level conversion data form the first region update data.

7. The driving method as claimed in claim 5, wherein the step of updating the display area according to the first region update data comprises:
searching a gray level lookup table according to the first region update data, so as to obtain a plurality of voltage waveform schemes corresponding to each of the pixels in the first update region; and
updating the first update region of the display area according to the voltage waveform schemes.

8. The driving method as claimed in claim 5, wherein the display process module produces an update signal, and when the display process module is in the update period for updating the display area, the update signal is at an update level, otherwise the update signal is at a terminate level, and
when the update signal is at the update level, the image processing unit continues to receive at least one second update regions to produce the second region update data, and when the update signal is at the terminate level, notifying the image processing unit to transmit the second region update data to the display process module, and the display process module updates the display area according to the second region update data.
